(19) United States
(12) Patent Application Publication
(10) Pub. No.: US 2006/0224525 A1
(43) Pub. Date: Oct. 5, 2006

(54) Multi-operator media content broker

(75) Inventors: Steinar Dahlin, Jarfalla (SE); Rolf Blom, Jarfalla (SE); Jerker Widmark, Sundbyberg (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (publ), Stockholm (SE)

(21) Appl. No.: 11/095,666

(22) Filed: Apr. 1, 2005

(51) Int. Cl. G06Q 99/00; H04L 9/00; H04K 1/00

(52) U.S. Cl. 705/80

(57) ABSTRACT

A broker node is provided, acting as an intermediate administrator for all operators during service content distribution. A content provider has a single relation to the broker. This broker has in turn relations to a number of other operators. The content provider provides the communication content. A list of targeted users or subscribers is compiled by the broker. Preferably, the broker collects necessary subscriber attributes, such as position, device information and access properties, from the other operators. The communication content is preferably modified according to the collected attributes and the content can subsequently be delivered to the subscribers in a best possible way. The broker collects payment from the subscribers and reimburses the media content supplier. In a first aspect, the broker is a distributor and payment administrator for service content. In another aspect, the broker is a mediator of use of inter-operator relations to a third-party content provider.

### TECHNICAL FIELD

The present invention relates in general to communication of service content and in particular to inter-operator brokerage of such service content.

### BACKGROUND

Telecommunication operators are today building up several standardized routing capabilities for communication services, sessions and/or media across their collective networks. The motive force is to be able to provide person-to-person connectivity for anyone-to-anyone regardless of particular user-operator relations. Examples of routing capabilities of these services, sessions and/or media are telephony, SMS, MMS, IMPS, Email and now also the coming IMS. Each of these examples has their own addressing structure that makes it possible to route from any user to any other user active within the specific addressing, service or session scheme.

Content providers of different service contents, e.g. communication service content, media content etc., have need for distributing their service content to specified users. In typical cases, a large number of users spread being associated with a number of different operators are the tentative targets for such service content. To this end, content providers can use the routing structures described above Just as any other user can, and they will in such a case also be considered as a “normal” user. The content providers can in that way route their service content to anyone desiring it. However, delivering service content when acting as a user among other users has some drawbacks, mainly in terms of ability to adapt the actual content to the type of terminal the content is delivered to and/or the type of access the content is delivered through. This in turn reduces the possible price that can be associated with such products.

Another alternative that is available for content providers is to create a direct relation to the different operators. Such relations can provide access to current terminal capabilities of the users associated with the operator and the operator access capabilities by making use of the operator's third party interfaces. This becomes a way to obtain e.g. the position of a targeted user, which may be important for the actual delivery of the content. However, in order to be able to provide the service to all possible users, the content provider has to create such relation to all operators of interest. Since there are numerous operators spread over the entire globe, such relations might be difficult to obtain, at least for smaller content providers. This procedure leads to that this approach is very time consuming, administratively difficult and costly for the content provider. There is thus a high barrier for any content provider to use such solutions.

### SUMMARY

A general problem with prior art telecommunications systems is that it is difficult to provide service content to a multitude of targeted users of different telecommunication operators in a manner that is well suited to individual terminal and access capabilities. Another general problem with prior art service content provision is that the difference between the costs for providing the service content and the possible charging for the service content provision is very low.

A general object of the present invention is thus to improve service content distribution from content providers over the collective network of a multitude of telecommunication operators to targeted users. Another general object of the present invention is to improve possible profits connected to service content distribution. A further object of the present invention is to provide methods and arrangements facilitating creation of relations between a content provider and a multitude of telecommunication operators. A subsidiary object of the present invention is to create a communication structure enabling a higher development speed of end user applications.

The above objects are achieved by methods and arrangements according to the enclosed patent claims. In general words, the basic concept of the present invention is a provision of a broker node acting as an intermediate administrator, handler or distributor for all operators. A content provider has a single relation to the broker. This broker has relations to a number of other operators. In this manner it is possible for the content provider to reach all users of all operators having a relation to one single actor. The content provider provides the communication content. A list of targeted users or subscribers is compiled by the broker. Preferably, the broker collects necessary subscriber attributes, such as position, device information and access properties, from the other operators. The communication content is preferably modified according to the collected attributes and the content can subsequently be distributed or delivered to the targeted subscribers in the best possible way. The broker node collects payment from the subscribers for said service content and reimburses the media content supplier. The broker according to the present invention acts in two aspects. In a first aspect, the broker is a distributor and payment administrator for service content. In another aspect, the broker is a mediator of use of inter-operator relations to a third-party content provider, and payment routines connected thereto.

An advantage with such an arrangement is that it constitutes a structure, which enables a high development speed of end user applications. The invention provides possibilities that not all services have to be identically implemented at all operators. Instead, the services are usable through all operators as implemented in one. Another advantage is that the final service content has a potentially higher value for the subscriber, which may imply a higher price. This higher price can increase the profit of the different operators, the broker as well as of the content provider. Furthermore, the content provider is released from time consuming and costly operator relation negotiations.

### BRIEF DESCRIPTION OF THE DRAWINGS

The invention, together with further objects and advantages thereof, may best be understood by making reference to the following description taken together with the accompanying drawings, in which:

FIG. 1 is a block scheme illustrating routing capabilities across operator borders;

FIG. 2 is a block scheme of a prior art system for content provision;

FIG. 3 is a block scheme of another prior art system for content provision;

FIG. 4 is a block scheme of an embodiment of a system for content provision according to the present invention;

FIG. 5 is a block scheme illustrating relations between parties in a system for content provision according to the present invention;

FIG. 6A is a block scheme of an embodiment of a content provider and an embodiment of a content handling subsystem of a broker according to the present invention;

FIG. 6B is a block scheme of another embodiment of a content provider and an embodiment of a content handling subsystem of a broker according to the present invention;

FIG. 6C is a block scheme of yet another embodiment of a content provider and an embodiment of a content handling subsystem of a broker according to the present invention;

FIG. 7 is a schematic illustration of information flow in an embodiment of a system according to the present invention;

FIG. 8 is a schematic illustration of information flow in an embodiment of a system according to the present invention comprising privacy scripts;

FIG. 9 is a schematic illustration of payment flow in an embodiment of a system according to the present invention;

FIG. 10A is a flow diagram of main steps of an embodiment of a method according to a first aspect of the present invention;

FIG. 10B is a flow diagram of main steps of an embodiment of a method according to a second aspect of the present invention; and

FIG. 11 is a block scheme of an embodiment of a system for content provision according to the present invention, enabling anonymity.

### DETAILED DESCRIPTION

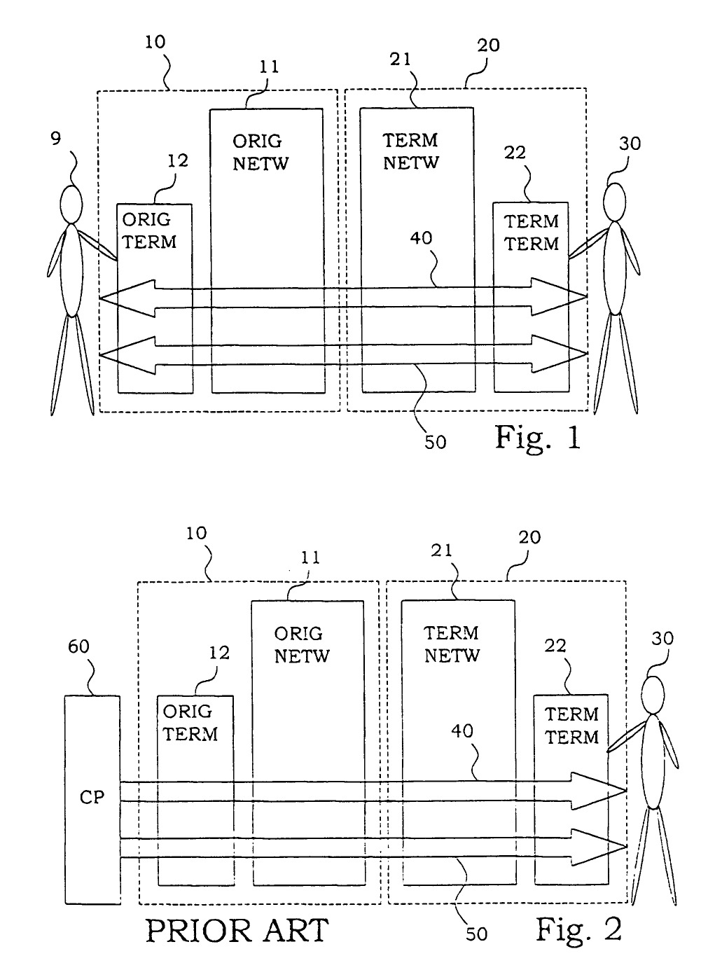

In telecommunication networks of today, routing capabilities for services, sessions and media across operator boundaries are well established. FIG. 1 visualise such arrangements by a schematic block scheme. An originating user 9, being a subscriber of an originating network operator 10, wants to distribute e.g. media content to a terminating user 30, being a subscriber of a terminating network operator 20. An originating terminal 12, connected to an originating network 11 provides the media content, which is transferred via the originating network 11 and a terminating network 21 to a terminating terminal 22. By using addressing structures of a particular communication, such as telephony, SMS (Short Message Service), MMS (Multimedia Messaging Service), IMPS (Instant Messaging and Presence Service), e-mail or IMS (IP Multimedia Service), any originating user 9 can reach any terminating user 30 via routing capabilities 40, 50. The arrow 40 represents telephony, SMS, MMS or IMPS using e.g. E164, and the arrow 50 represents IMS using e.g. SIP URI.

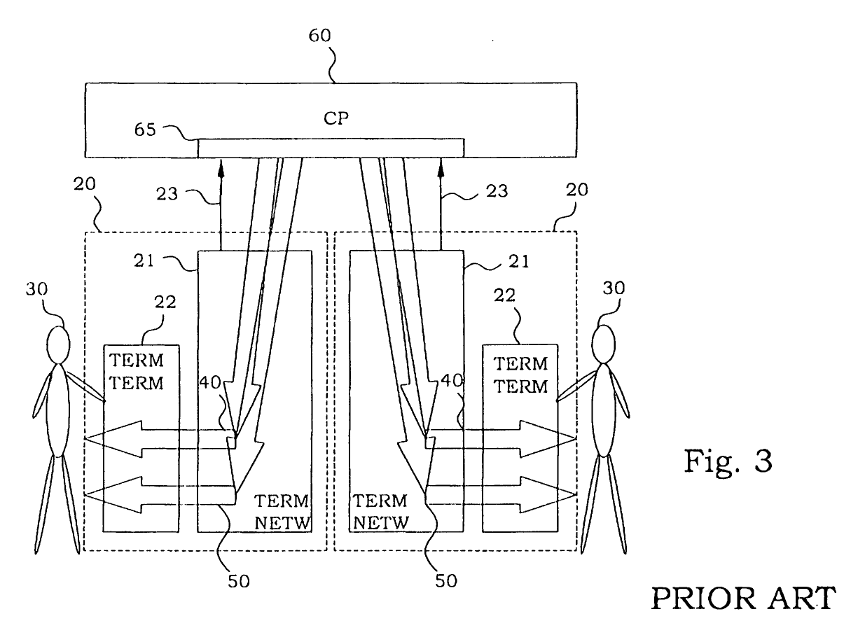

When turning into providers of service content, a content provider may according to prior art act as an ordinary user. Such a situation is depicted in FIG. 2. A content provider 60 is here providing the original service content, 2, which then is communicated to the end user 30 using the conventional routing capabilities. In the present disclosure, the expressions “content” or “service content” are used in a relatively broad meaning. Non-exclusive examples are e.g. media content, communication service content, advertisements, information service content etc.

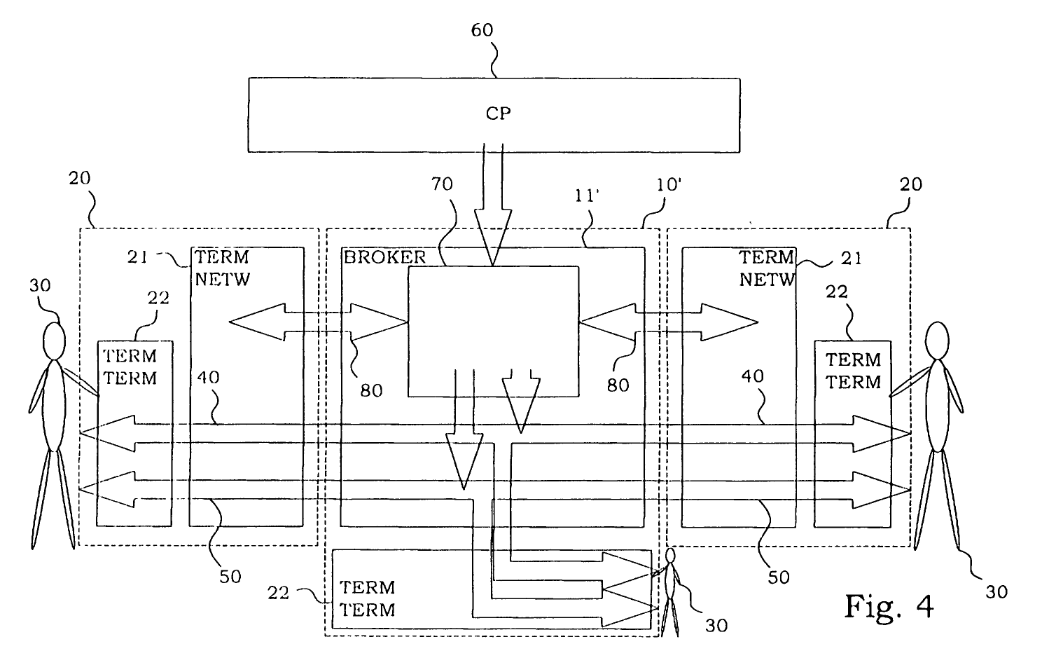

The content provider may also have a more direct connection to the communication network operators. FIG. 3 illustrates a situation where a content provider 60 is going to provide its content to users 30 of more than one network operator 20. The content provider 60 establishes a relation to all the different network operators 20. The operators 20 may in a best case provide information 23 about access properties within the network and/or about capabilities of subscriber devices. A content modifier 65 of the content provider 60 can then use such information 23 to adapt the content, before the content is transferred, using the routing systems of the network operators. The content provider 60 has in such a concept to invest much effort in establishing operator relations and in modifying treatment. Furthermore, the network operators 20 also have to put efforts in achieving relations to all possible content providers.

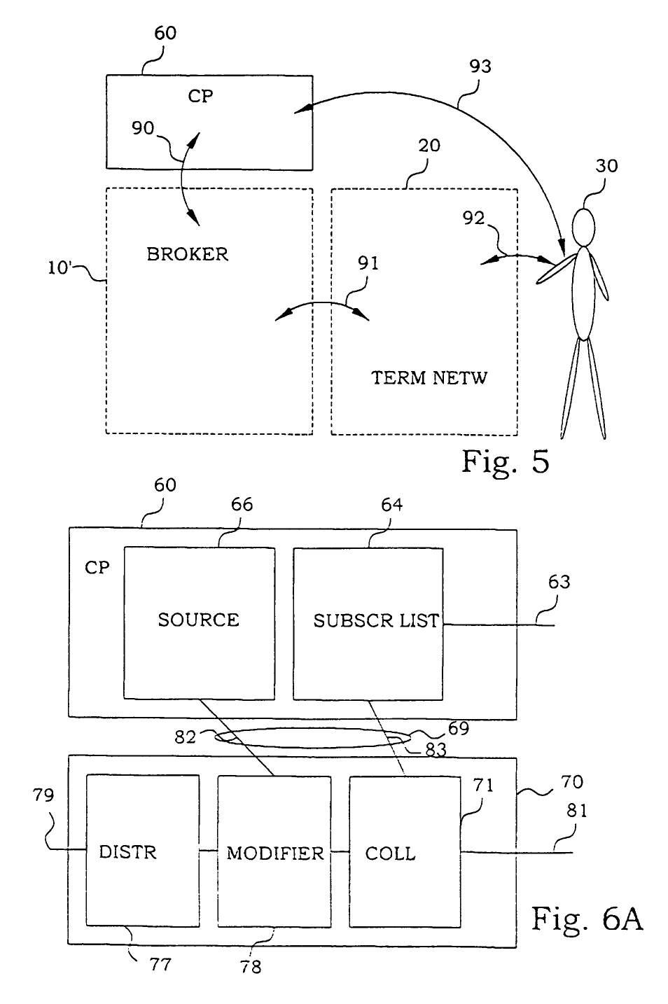

According to the present invention, an alternative configuration is proposed. FIG. 4 illustrates one embodiment of a system according to the present invention. The content provider 60 has established a single relation to one central operator 10′, in the present disclosure denoted as a broker. This broker is typically a telecommunication network operator. An administrating network 11′ of the broker 10′ comprises a content handling subsystem 70, arranged for administrating service content. This content handling subsystem 70 is typically implemented in a network node, but can also be implemented in any other network device as well as as a distributed subsystem.

The broker 10′ has typically established relations with other network operators 20 for enabling exchange 80 of certain subscriber attributes, such that subscriber position data, subscriber device information and/or subscriber access properties. Agreement between the operators and the broker determines the situations, data content, extent, economic compensation etc. under which such exchange 80 may take place.

The broker 10′ has also established a relation to the content provider 60, governing the types of data, transfer technologies etc. for data exchanged between the broker 10′ and the content provider 60. The content handling subsystem 70 receives content to be delivered to a number of users in the collective network of all operators. The content is in the present embodiment modified to suit the different end users, their needs and capabilities in a best possible way by using the exchanged user attribute data 80. The modified content is then distributed using the conventional routing capabilities 40, 50.

The network of a broker may also simultaneously function as a terminating network, when a user targeted for receiving the content is subscriber of the broker acting as a network operator. This is illustrated by the bottom part, where a user terminating terminal 22 is illustrated within the broker 10′.

In such a configuration, an inter-operator relation can be reused for handling content from a multitude of content providers. At the same time, a content provider only has to establish one single operator relation. In other words, the configuration described above opens up for the operators to make collective use of the service/session/media routing anyone-to-anyone in their business setup between each other and with content providers.

The operators/brokers have an agreement on attribute sharing with each other, making it possible for the broker to ask for attribute values of another operator's user. The preferred technology for that is the 3GPP standardised Generic User Profile (GUP) solution, other candidates are the Liberty Alliance solution.

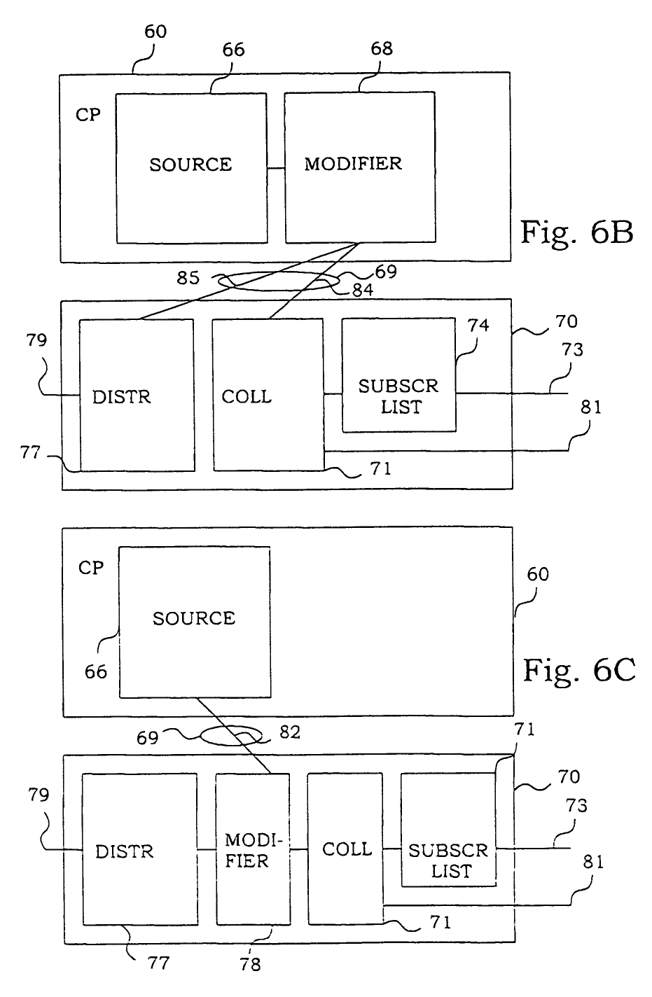

The configuration of FIG. 4 relies on that a number of relations or agreements between different parties are established. This is schematically illustrated in FIG. 5. A user 30 has a subscriber relation 92 with a network operator 20. The subscriber relation 92 may comprise rules about to what extent user attributes are free to be used by the operator 20, i.e. privacy considerations. The subscriber relation 92 may also e.g. regulate to what extent economical transactions can be made by the operator 20 on behalf of the user 30.

The network operator 20 has an inter-operator relation 91 with broker 10′ based on mutual trust. Such relation 91 governs, as mentioned above, what user attribute data can be exchanged, and under what conditions. Such relations 91 are typically symmetrical, i.e. any of the operators may act as a broker for different content providers. The relations 91 preferably also define formats and means for exchanging the information.

The broke 10′ has a relation 90 to the content provider 60. This relation governs the task that the broker accepts to perform on behalf of the content provider 90. As being described further below, different divisions of responsibility can be feasible, and may also easily be coexisting. One relation 90 may cover a particular content or all contacts between a particular pair of content provider 60 and broker.

Finally, a relation 93 between the content provider 60 and the tentative user 30 has to be present. The relation 93 may be a direct relation, where commitments and conditions are agreed directly between the parties. However, by the influence of the other relations 90-92 of FIG. 5, the relation 93 can also be an indirect relation, where e.g. the broker 10′ may act on behalf of the content provider 60 and/or the network operator 20 may act on behalf of the user 30, at least to some extent.

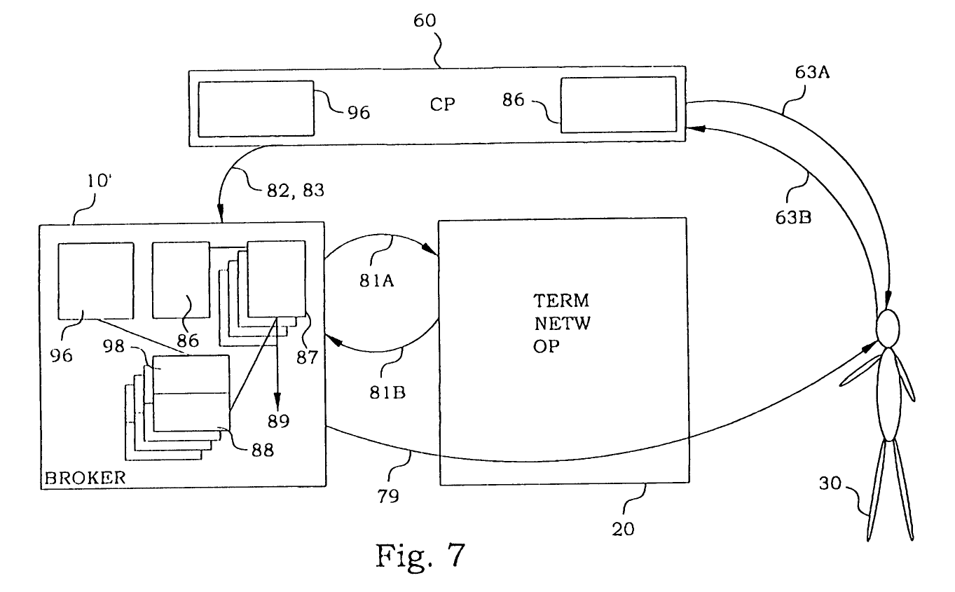

The relation between the broker and the content provider determines the division of responsibilities between the content provider 60 system and the broker content handling subsystem 70. In FIG. 6A, a block scheme of one embodiment of the content provider 60 system and the content handling subsystem 70 is illustrated. The content provider 60 comprises a content source 66. The content of the content source 66 is intended for a multitude of users. A subscriber list compiler 64 uses connections 63 for achieving a list of users that are targeted for the content.

The content from the content source 66 is transferred 82 to a content modifying unit 78 of the content handling subsystem 70. Also the subscriber list or a representation thereof is transferred 83 from the content provider 60 to an attribute collector 71 of the content handling subsystem 70 over a content provider interface 69. The attribute collector 71 uses in the present embodiment the inter-operator relations for requesting useful user attributes of the users present in the received subscriber list. Such communication takes place over inter-operator interfaces 81 adapted for management signalling with operators of a plurality of mobile communication network. The subscriber list accompanied by associated user attribute data is provided to the content modifying unit 78. In the content modifying unit 78, the content is modified to suit the different user attributes as good as possible. More detailed examples of such handling are given further below. The modified content together with subscriber lists indicating which user that should have what type of content is provided to a distributing means 77, which delivers the content over data traffic interfaces 79 adapted for communication with subscribers of the plurality of mobile communication networks.

In the embodiment of FIG. 6A, the content provider 60 has the main is responsibility for the content as well as the provision of the subscriber list, whereas all further actions are handed over to the content handling subsystem 70.

Another embodiment, based on a different division of responsibilities, is illustrated in FIG. 6B. Here, the content provider 60 takes responsibility for both the actual provision of the original content as well as any modification to suit different targeted users. A content modifying unit 68 is thereby provided at the content provider 60. Instead, the responsibility for obtaining the list of tentative users is handed over the content handling subsystem 70. The content handling subsystem 70 thus comprises a subscriber list compiler 74 using connections 73 for achieving a list of users that are targeted for the content. The result of such targeting actions is then easily handed over to the attribute collector 71. The attribute collector 71 provides in this embodiment the subscriber list 84 accompanied by associated user attribute data to the content modifying unit 68 over the content provider interface 69. The content modifying unit 68 modifies the content according to the received information and returns modified content 85 to the content handling subsystem 70, which subsequently distributes the content.

In FIG. 6C, an embodiment of yet another responsibility division is illustrated. Here, the content provider 60 minimises its own participation. The content provider 60 here only provides the content handling subsystem 70 with the original content, whereby the content handling subsystem 70 performs all remaining steps in analogy with earlier embodiments.

In order to increase the understanding of the benefits of the methods and devices according to the present invention, a number of illustrative examples will be presented below. As a model situation, a concert event taking place in a limited concert area is used. A multitude of artists are going to perform on a stage and as an additional service for the spectators, the arranger of the concert has a film team operating back-stage, providing additional media material, such as interviews or just general back-stage film sequences.

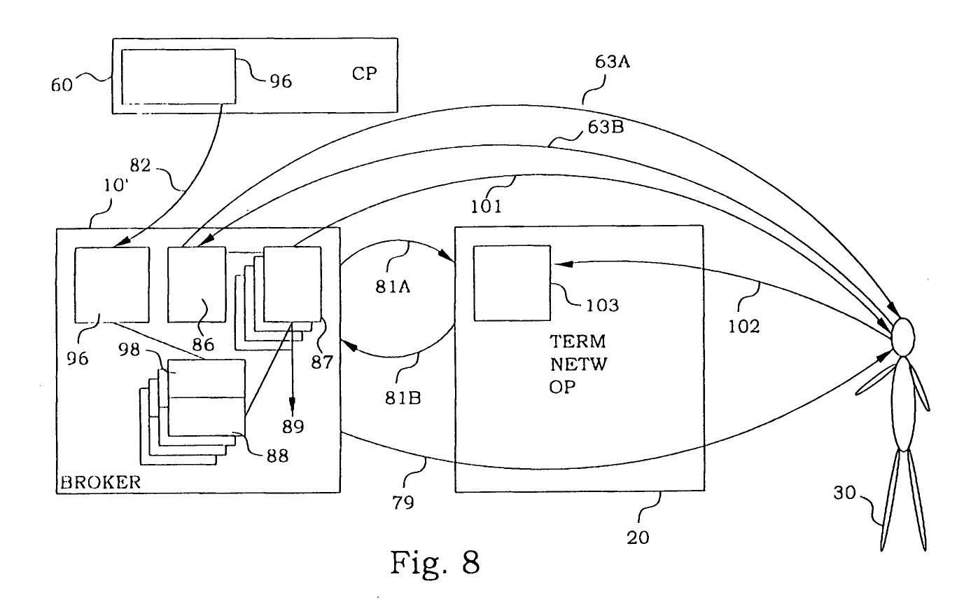

FIG. 7 schematically illustrates the different acting parties. The content provider 60 first has to reach possible targets for the additional media material. In advertisements at the entrance to the concert area as well as distributed over the concert area, the content provider informs that “films showing artists back stage” are available. In the advertisement, there is an instruction to send an SMS containing the word “BackStageFilms” to a specific telephone number. The films will then be delivered when available, if the user is present within the concert area. The area constriction will prohibit non-spectators to benefit from viewing interesting media content. The advertisement also tells what costs that are involved. This advertisement is illustrated by the arrow 63A.

A user 30 that is interested in having the back stage material replies 63B on the advertisement 63A, by sending an SMS to the specific phone number including the word “BackStageFilms”. The specific phone number belongs to the content provider 60 and when the SMS is received, the content provider 60 detects the code word “BackStageFilms” and takes the originating SMS address, e.g. the MSISDN, of the SMS and adds that to a list 86 of users subscribing to the content delivery offer.

The concert starts, and the so does the work of the back stage film team. When the content provider 60 has any new content 96 to offer, it is sent 82, 83 together with the list 86 of MSISDNs of those subscribing to it to the broker 10′. The broker 10′ (or the content handling subsystem of the broker) goes through the list 86 of MSISDNs and divides it according to operator responsible for each number into a list 87 per operator that has users in the original list 86. The broker 10′ sends a request 81A to each operator in question, asking for position, capability of current device, capability of current access and preferred delivery method IMS or MMS. For users belonging to a network of the broker 10′ itself, such a request is of course handled internally.

The different terminating network operators 20 reply 81B on the requests 81A, providing user attribute data for the targeted users of respective operator. The broker 10′ uses this received information to make a new division of the subscriber list. The subscriber list 86 is now divided into part lists 88, in which users having the same or similar demands on access and presentation capabilities are collected. For instance, a division between users that shall have the content delivered through MMS and those that shall have the content through IMS can be performed. Targeted users that are not present within the concert area are removed 89 from receiving the media content.

The broker 10′ modifies the content to suit the different demands of the part lists 88, i.e. provides modified content 98 associated with respective part list 88. Finally, the broker 10′ sends 79 the modified content to the users of the part lists 88 using conventional routing capabilities. In this particular example, a video MMS to each MSISDN on the MMS list and a streaming invite to each MSISDN on the IMS list. Generally, content can be modified and/or recoded to fit e.g. terminal screen size depending on terminal type or down-coded to fit e.g. reduced access capability.

Anyone skilled in the art understands that the above illustration corresponds to a system e.g. according to FIG. 6A, where the content provider is responsible for compiling the list of users and where the broker is responsible for the content modification. If other responsibility division, such as e.g. the ones presented in FIGS. 6B and 6C, the information streams will be modified accordingly.

The above illustrative example presents content distribution on a very basic level. Further aspects can also be considered. The issue of guaranteed quality is a delivery requirement that can be considered. Such aspect is required in cases of e.g. network congestion and when the content is sold with delivery guarantee. This is easily included in the configuration above. The request 81A for user attributes will then also include a request for information about if the user has subscribed to guaranteed quality delivery. Upon receiving the attributes, the broker 10′ creates part lists 88 also based on guaranteed quality delivery status. When delivering the modified content, the deliveries to users that have guaranteed quality delivery are marked accordingly.

Digital Rights Management (DRM) is also an important factor to attract lasting high valued content to the market. In this context it is a matter of checking the DRM level present in the terminal delivered to. This can be treated as an attribute among other attributes within the above scheme. The ability to push a higher DRM capacity to the terminal could also be incorporated as a step.

As an example, the content provider consider the content valuable and decides to require DRM capability level 2 in the user device, in order for the subscription to be valid. The broker 10′ sends an attribute request asking about DRM level available in the device the user is using and requiring it to be at least of level 2. The terminating network operator 20 checks the user device capability. If the user device is DRM level 2 compatible, this information is returned. If the level is less than 2, then the terminating network operator 20 tries to update the device to fulfil level 2, if possible. If the update successes, level 2 compatibility is returned, otherwise the terminating network operator 20 returns a DRM level less than 2. The broker 10′ processes the returned DRM levels, and if the level is less than 2, the broker 10′ removes the user from the lists of users that will be provided with the content. Preferably, an indication of the removal and the reason for it is transferred to the user 30.

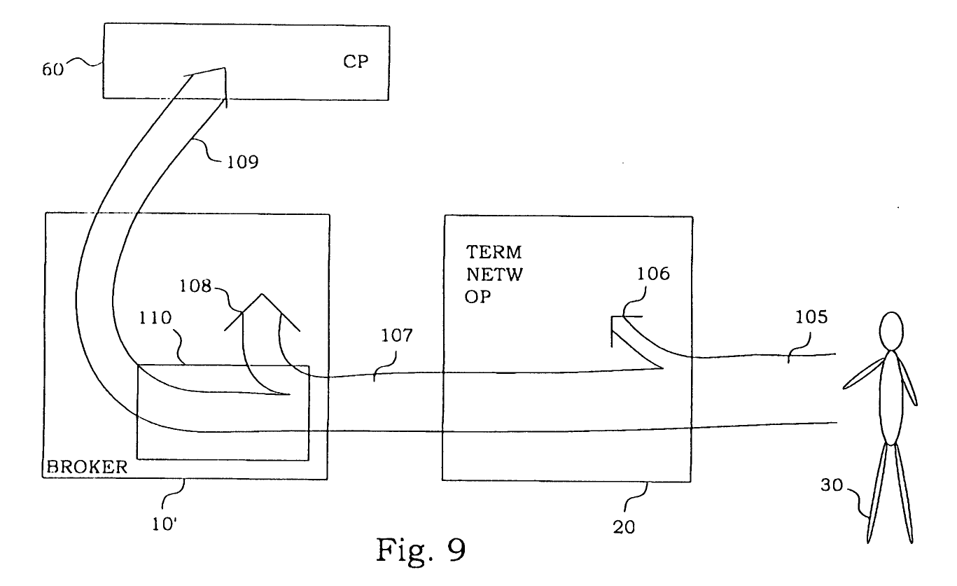

Privacy, i.e. the question about what information that is allowed to be distributed to other parties, is another issue that can be incorporated within the scheme above. Privacy is an addition of large relevancy, since it typically is considered that it is required in some form to protect the user integrity. As mentioned further above, at least a part of the user privacy may be governed by the subscriber agreement or other relation between the operator and the user. Such regulations may concern general privacy, i.e. not towards any other particular extern party or at any particular event. It is, however, not very common to allow operators to handle user attributes totally free with respect to external parties. In such cases, a general privacy restriction is typically present, prohibiting the network operator to distribute user attributes to external parties only according to his own considerations. For the scheme of the present invention to operate properly also under such circumstances, such obstacles may be temporarily removed by using event or party associated privacy handling schemes according to the following description, which is schematically illustrated by FIG. 8.

In the embodiment of FIG. 8, the compiling of the subscriber list is handled by the broker 10′. The advertisement 63A and the reception of the replies 638 are thus controlled by the broker 10′. This means that the list of targeted subscribers 36 is built up at the operator. When the broker 10 receives the reply 63B, an automated privacy configuration is activated in the present embodiment. The broker 10′ sends an automated privacy configuration script 101 to the “from” address in the SMS, i.e. a targeted user, via e.g. MMS. The scripts are accompanied by a request to forward 102 that script to a defined address 103 at the user's operator 20. This script provides the ability for the user's operator 20, i.e. the terminating operator, to the validity of coming attribute requests from the broker 10′. Scripts configuring privacy are required to be signed by the creator. The terminating operator checks that it is created by a trusted entity and signed by the user.

When the broker 10′ sends the request 81A for user attributes, the terminating operator 20 checks the validity of the attribute requests against each users privacy configuration 103. For those users that are present in the privacy configuration list 103 and have the proper privacy setting, the requested attribute values are returned 81B. The broker 10′ sorts out users 89 that do not have any suitable privacy configuration, i.e. where no user attributes are returned. In an alternative implementation, the broker 10′ may create separate a part list of users having no suitable privacy configuration. The content to be distributed to the users of that part list is then modified to suit a “lowest” possible level of terminal and network access capabilities.

Due to the above script handling procedure, a privacy level approved by the user at all instances, can be used to provide a best possible choice of distribution.

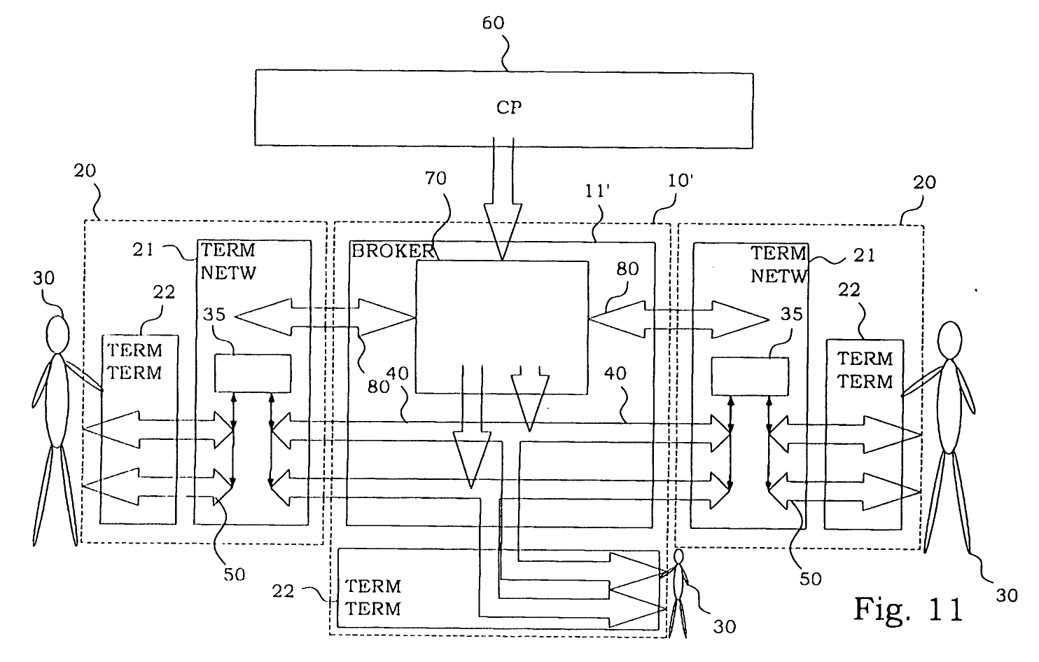

In some situations, a user may also want to maintain its anonymity, although still wanting to achieve the content. For instance, if the subscriber does not know whether the content provider is an operator that can be trusted, the subscriber may choose not to reveal its true identity for the content provider. In other words, the subscriber wants to achieve availability to the content, however, not revealing its own identity. Also anonymity schemes may then be comprised in the above configuration, using subsystems in the broker 10′ or the terminating network operator 20 as anonymity preserving subsystems. One embodiment of such a system is illustrated in FIG. 11. The terminating networks 21 of the network operators 20 then comprises an anonymity port 35. The anonymity port 35 comprises functionality for providing temporary time-limited associations between a subscriber address and a temporary routing address. This association information is not available through any user attribute data exchange.

The operation of the anonymity port 35 is easiest understood by studying an example. When a content provider 60 or broker 10′ advertises the content services, also information about anonymous subscriptions is provided. The advertising could e.g. comprise the information “Anonymous subscription is accepted. Include “0701234567” and send the SMS to your operator's anonymity port.” The user sends an SMS to its home operator anonymity port 35 with the content provider or broker SMS address 0701234567 and an identification for the actual content of interest. The operator 20 anonymity port 35 selects a temporary routing number and associates that with the “from” address of the received SMS. Routing numbers are preferably structured so that they can be understood that they are routing numbers and not ordinary telephone numbers. The operator 20 forwards any call or message addressed to the routing number to the associated original address for the validity time of the association. The anonymity port 35 also forwards the SMS to the content provider address “0701234567”. The broker 10′ takes the “from” address in the SMS, i.e. now the routing number, and adds that to the list of users subscribing to the content delivery offer.

When the broker 10′ requests user attributes of the subscriber, the anonymity port 35 can translate the routing number into the original number and provide, if permitted, the correct user attributes 80 to the broker 10′. Still, the identity of the end user 30 is not revealed, just which operator he belongs to. When the actual content is distributed, the content will be addressed to the routing address, which brings the content to the anonymity port 35. The anonymity port 35 forwards the content to the subscriber 30, using its internal association.

In such an arrangement, any charging for the content has to pass via the terminating network operator 20.

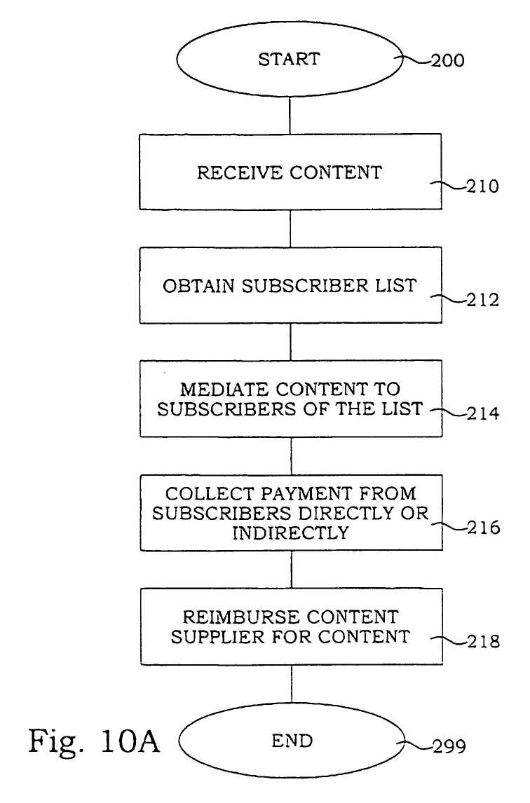

One of the tasks for the broker is to handle the payment for the service content. In a typical case, the receiver has to pay for the service content, which is in analogy with so-called B-party charging. FIG. 9 illustrates a typical example of payment flow in an embodiment of a system according to the present invention. When the service content is delivered it is typically marked for B-party charging and assigned a charging value, corresponding to the values advertised by the content provider 60. The terminating network operator 20 bills the user 30 or debiting their prepaid accounts for the delivered content according to the provided charging value, represented by the flow 105. A payment administrating unit 110 of the broker 10′ bills the terminating network operator 20 for the delivered content according to their is accounting agreements, corresponding to a value 107. The difference amount 106 becomes the compensation for the terminating network operator 20 participation. Finally, the payment administrating unit 110 of the broker 10′ calculates a reimbursement value 109 for delivery to the content provider 60 according to their mutual agreement. Also here, the difference 108 in charged and reimbursed amount constitutes the compensation for the broker 10′ participation.

The broker action is financially possible due to two main reasons. The final content quality is generally higher, which means that the price the subscriber 30 is willing to pay is higher than for prior art solutions. This gives an extra cost margin to distribute to the participating parties. Furthermore, the content provider 60 is generally released from many tasks that typically cost large efforts, and can instead concentrate on the main tasks of providing service content. By handing these tasks over to the broker 10′, the content provider 60 is typically willing to compensate the broker 10′, which ends up in a larger efficient difference between charged and reimbursed amounts for the broker 10′.

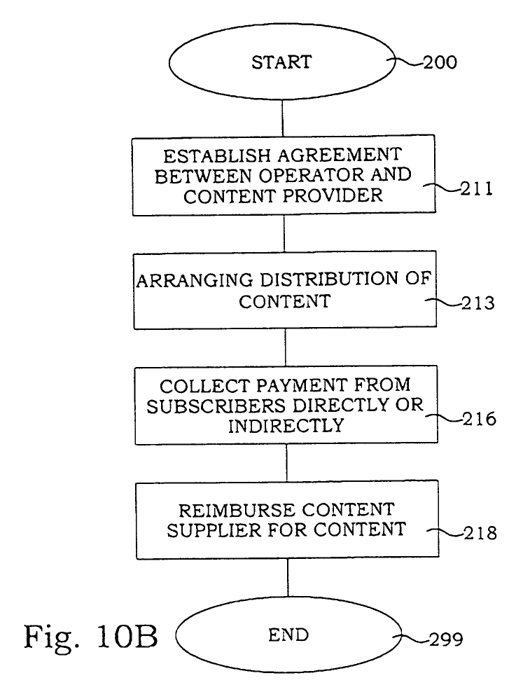

FIG. 10A is a flow diagram of main steps of an embodiment of a method according to a first aspect of the present invention. The procedure starts in step 200. In step 210 service content, e.g. media content, is received at a broker. The content is typically provided by or from a content provider. A subscriber list of targeted users is obtained in step 212. Such step can be provided either by the content provider, or by a subsystem of the broker. In step 214, the content is mediated to users of the subscriber list. The content is then preferably modified according to user attributes of respective user. In step 216, payment from subscribers is collected. This collection takes place either directly between the broker and the subscribers, or indirectly via the network operator of the subscribers. In the latter case, the network operator charges the subscribers according to agreements with the broker and the broker bills the network operator for an agreed part of that subscriber amount. The broker reimburses the content supplier for the content in step 218. The procedure ends in step 299.

FIG. 10B is a flow diagram of main steps of an embodiment of a method according to a second aspect of the present invention. The procedure starts in step 200. In step 211 an agreement is established between an operator and a content provider concerning distribution of service content, e.g. media content to subscribers of a multitude of operators. In step 213, the multi-operator distribution of content is arranged according to the agreement. The content is then preferably modified according to user attributes of respective subscriber. In step 216, payment from subscribers is collected. This collection takes place either directly between the broker and the subscribers, or indirectly via the network operator of the subscribers. In the latter case, the network operator charges the subscribers according to agreements with the broker and the broker bills the network operator for an agreed part of that subscriber amount. The broker reimburses the content supplier for the content in step 218. The procedure ends in step 299.

The structure described here enable a market structure where one particular telecommunication operator to act as administrator or broker for the operator collective, thus making it possible for an application industry to be innovative and grow faster. The operators are still in control as they are providing the most of the information regarding their users as well as configure the basic capability needed.

Agreements between operators are required. These agreement covers generics interconnect aspects on session routing level and enabler level as well as general attribute sharing capability. The ways these are used in a service context are not part of the agreement and need only to be known on one side of the relation. Privacy is furthermore considered as a generic service provided by each operator to their customers.

The structure enables the different operators to act and develop independently thus removing the time consuming activity of standardizing is on a service level. Another advantage is that single services need not be implemented at all operators in order to work across all users.

An important aspect of the invention is the way standardised interface solutions are combined to provide the overall capabilities and characteristics making it possible for each operator to reach all users regardless of the operator relation.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. Method for mediating service content from a service content provider to subscribers of a plurality of mobile communication networks, comprising the steps of:
receiving, in a broker arrangement of a broker, service content from said service content provider;
obtaining, in said broker arrangement, a list of subscribers of said plurality of mobile communication networks to which said media content is to be distributed;
mediating, from said broker arrangement, said service content to subscribers of said list;
collecting, by said broker, payment from said subscribers for said service content;
reimbursing said service content provider for said service content from said broker.

2. Method according to claim 1, comprising the further step of:
establishing a broker agreement between an operator of said broker and an operator of said service content provider;
said broker agreement controlling conditions for said multi-operator service content mediating step and said reimbursing step.

3. Method according to claim 1, comprising the further steps of:
collecting, in said broker arrangement, subscriber attributes for said subscribers of said list from operators of said plurality of mobile communication networks; and
modifying, in said broker arrangement, said service content according to said collected subscriber attributes;
whereby said step of mediating comprises delivering, to subscribers of said list, said service content modified according to respective subscriber attributes.

4. Method according to claim 3, wherein said step of collecting is performed according to mutual trust relations with said operators.

5. Method according to claim 1, wherein said step of obtaining a list of subscribers comprises the step of receiving data representing said list of subscribers from said content provider.

6. Method according to claim 1, wherein said step of obtaining a list of subscribers comprises the step of gathering orders for said service content from subscribers of said plurality of mobile communication networks.

7. Method according to claim 1, wherein said step of collecting payment comprises the step of debiting said operators of said plurality of mobile communication networks for said delivery of said service content according to said mutual trust relations.

8. Method according to claim 1, comprising the further step of interrogate said operators about a financial relation between said subscribers of said list and respective operator according to said mutual trust relations before performing said mediating step.

9. Method for handling service content, comprising the steps of:
establishing a broker agreement between a service content provider and a particular telecommunication operator for multi-operator service content distribution;
said particular telecommunication operator having inter-operator mutual trust relations to other telecommunication operators;
arranging, by said particular telecommunication operator, distribution of service content according to said broker agreement;
collecting, by said particular telecommunication operator, payment from said subscribers for said service content, controlled by said inter-operator mutual trust relations;
reimbursing said service content provider for said service content distribution according to said broker agreement.

10. Method according to claim 9, comprising the further steps of:
receiving, by said particular telecommunication operator, service content from said service content provider;
obtaining, by said particular telecommunication operator, a list of subscribers of said plurality of mobile communication networks to which said service content is to be distributed.

11. Method according to claim 10, further comprising the steps of:
collecting, by said particular telecommunication operator, subscriber attributes for said subscribers of said list from operators of said plurality of mobile communication networks according to said inter-operator mutual trust relations; and
modifying, by said particular telecommunication operator, said service content according to said collected subscriber attributes;
whereby said step of distributing comprises delivering, to subscribers of said list, said service content modified according to respective subscriber attributes.

12. Broker arrangement for mediating service content from a service content provider to subscribers of a plurality of mobile communication networks, comprising:
content provider interface adapted for receiving service content from a service content provider;
means for obtaining a list of subscribers of said plurality of mobile communication networks to which said service content is to be distributed;
data traffic interfaces adapted for communication with subscribers of said plurality of mobile communication networks;
means for mediating said service content over said traffic interfaces; and
means for compiling data representing payment amounts for said service content delivery for said subscribers and data representing reimbursement of said service content supplier for said service content.

13. Broker arrangement according to claim 12, further comprising:
inter-operator interfaces adapted for management signalling with operators of a plurality of mobile communication network;
means for collecting subscriber attributes for said subscribers of said list over said inter-operator interfaces; and
means for modifying said service content according to said collected subscriber attributes;
whereby said means for mediating comprises means for delivering said service content modified according to respective subscriber attributes.

14. Broker arrangement according to claim 12, wherein said means for obtaining a list of subscribers comprises means for receiving data representing said list of subscribers over said content provider interface.

15. Broker arrangement according to claim 12, wherein said means for obtaining a list of subscribers comprises means for gathering orders for said service content from subscribers of said plurality of mobile communication networks.

16. Broker arrangement according to claim 12, further comprising:
means for collecting payment from said subscribers for said service content; and
means for reimbursing said media content supplier for said service content.

17. Broker arrangement according to claim 16, wherein said means for collecting payment comprises means for debiting said operators of said plurality of mobile communication networks for said delivery of said service content.

18. Broker arrangement according to claim 12, further comprising means for interrogating said operators about a financial relation between said subscribers of said list and respective operator, said means for interrogating being connected to said means for mediating, whereby an operation of said means for mediating being dependent of an output from said means for interrogating.

19. Mobile communication network, comprising a broker arrangement for mediating service content from a service content provider to subscribers of a plurality of mobile communication networks, said broker arrangement comprising:
content provider interface adapted for receiving service content from a service content provider;
means for obtaining a list of subscribers of said plurality of mobile communication networks to which said service content is to be distributed;
data traffic interfaces adapted for communication with subscribers of said plurality of mobile communication networks;
means for mediating said service content over said traffic interfaces; and
means for compiling data representing payment amounts for said service content delivery for said subscribers and data representing reimbursement of said service content supplier for said service content.
